(19) United States
(12) Patent Application Publication
(10) Pub. No.: US 2021/0134525 A1
(43) Pub. Date: May 6, 2021

(54) THIN-FILM INDUCTOR AND METHOD FOR MANUFACTURING THE SAME

(71) Applicant: Ralec Electronic Corporation, Kaohsiung (TW)

(72) Inventor: Tim Wang, Kaohsiung (TW)

(21) Appl. No.: 16/853,510

(22) Filed: Apr. 20, 2020

(30) Foreign Application Priority Data
Oct. 30, 2019 (TW) 108139292

(51) Int. Cl. H01F 41/04; H01F 27/28; H01F 27/32; H01F 27/29; H01F 41/12

(52) U.S. Cl. CPC H01F 41/042; H01F 27/2804; H01F 41/127; H01F 27/29; H01F 27/327

(57) ABSTRACT

A method for manufacturing a thin-film inductor includes the steps of a) forming a separation film on a base plate, b) forming a first magnetic layer on the separation film, c) forming, on the first magnetic layer, a coil unit and an electrically insulating member enclosing the coil unit, d) forming a second magnetic layer on the first magnetic layer to cover the coil unit and the electrically insulating member and fill a space defined by the coil unit, e) removing peripheral portions of the first and second magnetic layers until a part of the separation film is exposed to obtain a semi-product, f) forming a cover insulating layer on the exposed separation film and the semi-product such that two contact regions of the coil unit are exposed, and g) removing the base plate. A thin-film inductor made by the method is also disclosed.

### CROSS-REFERENCE TO RELATED APPLICATION

This application claims priority of Taiwanese Invention Patent Application No. 108139292, filed on Oct. 30, 2019.

### FIELD

This disclosure relates to a thin-film inductor and a method for manufacturing the same.

### BACKGROUND

With the advancement of semiconductor technology, it has become a trend to develop miniaturized electronic devices. To meet such requirements, various passive components installed in the electronic devices (e.g., resistors, capacitors, or inductors) need to be miniaturized.

Miniaturization of an inductor needs to take into account a quality factor (Q) thereof. For example, a mini molding choke is a type of integrally-formed inductor which is generally made by first coiling a wire to form a coil circuit, and then packaging the coil circuit to obtain a final product. However, it is difficult to miniaturize the mini molding choke since the coil circuit occupies too much space, resulting in limited space for disposing a magnetic material, thereby leading to poor performance of the thin-film inductor thus obtained.

### SUMMARY

Therefore, an object of the disclosure is to provide a thin-film inductor and a method for manufacturing the same that can alleviate or eliminate at least one of the drawbacks of the prior art.

According to the disclosure, the method for manufacturing the thin-film inductor includes the steps of:
a) forming a separation film on a base plate;
b) forming a first magnetic layer on the separation film;
c) forming, on the first magnetic layer, a coil unit and an electrically insulating member that encloses the coil unit, the coil unit and the electrically insulating member cooperatively forming a coil pattern;
d) forming a second magnetic layer on the first magnetic layer to cover the coil unit and the electrically insulating member and to fill a space defined by the coil pattern;
e) removing a peripheral portion of the second magnetic layer and a peripheral portion of the first magnetic layer until a part of the separation film below the peripheral portion of the first magnetic layer is exposed, so as to obtain a semi-product on the separation film;
f) forming a cover insulating layer on the exposed separation film and the semi-product in such a manner that two contact regions of the coil unit opposite to the first magnetic layer are exposed, the cover insulating layer and the separation film cooperatively forming a cover insulating element; and
g) removing the base plate from the cover insulating element to obtain the thin-film inductor.

According to the disclosure, the thin-film inductor includes a base magnetic unit, a coil structure, and a cover insulating element. The base magnetic unit includes a first magnetic layer, and a second magnetic layer disposed on the first magnetic layer. The coil structure includes a coil unit that is disposed in the second magnetic layer, and an electrically insulating member that is disposed around the coil unit to isolate the coil unit from the base magnetic unit. The cover insulating element covers the base unit and the coil structure such that two contact regions of the coil unit opposite to the first magnetic layer are exposed from the cover insulating element.

### BRIEF DESCRIPTION OF THE DRAWINGS

Other features and advantages of the disclosure will become apparent in the following detailed description of the embodiment with reference to the accompanying drawings, in which:

FIG. 1 is a perspective view illustrating an embodiment of a thin-film inductor according to the disclosure;

FIG. 2 is a schematic cross-sectional view of the embodiment of the thin-film inductor taken along line II-II of FIG. 1;

FIG. 3 is a flow chart illustrating a method for manufacturing the thin-film inductor according to the disclosure; and

FIGS. 4 to 9 are schematic cross-sectional views illustrating consecutive steps of the method according to the disclosure.

### DETAILED DESCRIPTION

Before the disclosure is described in greater detail, it should be noted that where considered appropriate, reference numerals have been repeated among the figures to indicate corresponding or analogous elements, which may optionally have similar characteristics.

Further, in describing representative embodiments of the present disclosure, the method and/or process of the present disclosure may be presented as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present disclosure should not be limited to the performance of their steps in the order written, and one skilled in the art can readily appreciate that the sequences may be varied and still remain within the spirit and scope of the present disclosure.

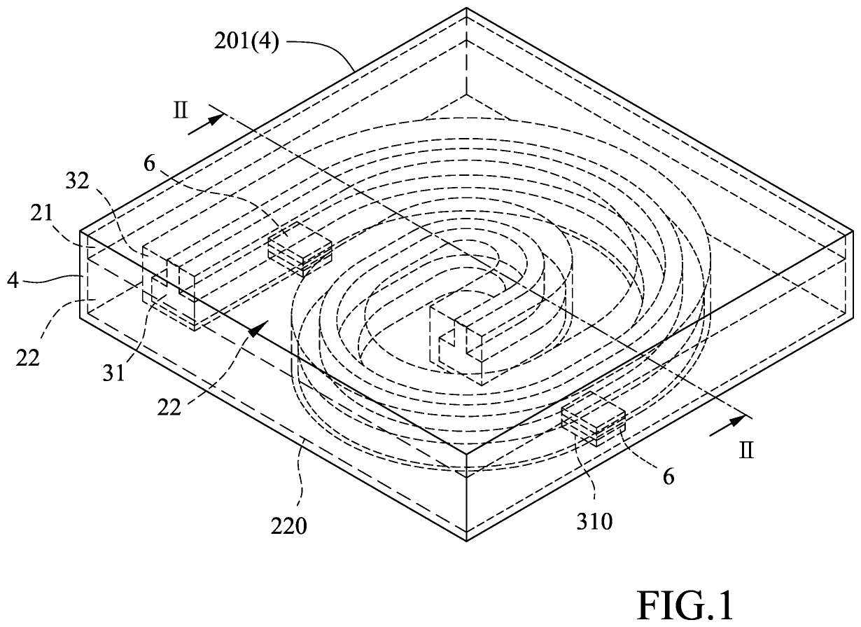

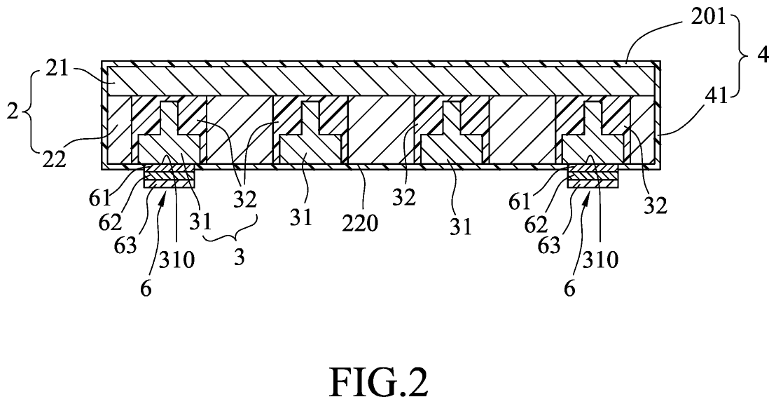

Referring to FIGS. 1 and 2, the embodiment of a thin-film inductor according to the disclosure includes a base magnetic unit 2, a coil structure 3, and a cover insulating element 4.

The base magnetic unit 2 includes a first magnetic layer 21 and a second magnetic layer 22 disposed on the first magnetic layer 21.

The coil structure 3 includes a coil unit 31 that is disposed in the second magnetic layer 22, and an electrically insulating member 32 that is disposed around the coil unit 31 to isolate the coil unit 31 from the base magnetic unit 2. In other words, the coil structure 3 has a coil pattern, and the second magnetic layer 22 fills a space defined by the coil pattern of the coil structure 3. The coil unit 31 may have a multi-layered structure, and the configuration, thickness and number of layers thereof may be selected and optimized by those skilled in the art according to practical requirements, and are not limited to the embodiment shown in FIGS. 1 and 2.

The cover insulating element 4 covers the base unit 2 and the coil structure 3 such that two contact regions 310 of the coil unit 31 opposite to the first magnetic layer 21 are exposed from the cover insulating element 4. The two contact regions 310 of the coil unit 31 may be flushed with a top surface 220 of the second magnetic layer 22 that is opposite to the first magnetic layer 21.

The thin-film inductor may further include two terminal electrodes 6 configured to be connected to a circuit board (not shown in the figures), and are disposed on the two contact regions 310. Each of the terminal electrodes 6 may include a copper layer 61 formed on the contact regions 310, a nickel layer 62 formed on the copper layer 61, and a tin layer 63 formed on the nickel layer 62.

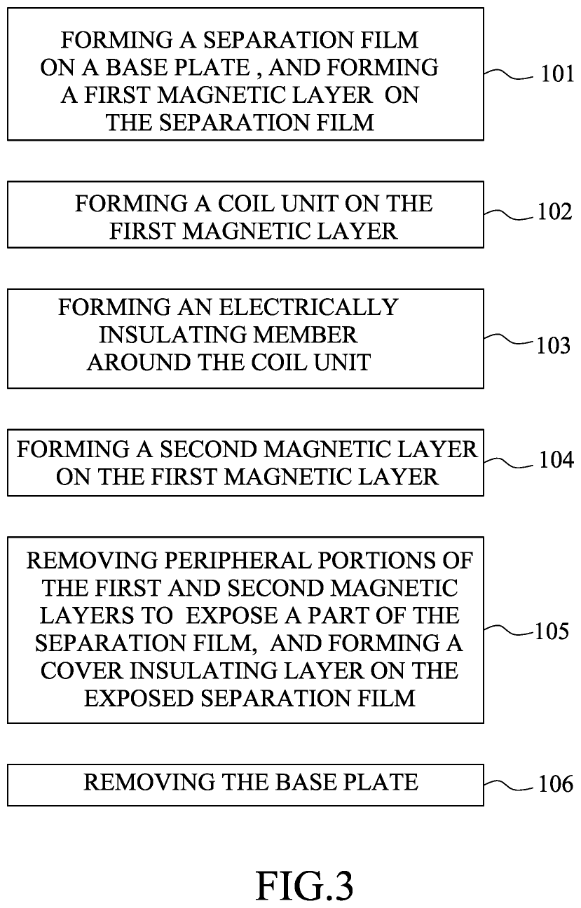

Referring to FIG. 3, a method for manufacturing the thin-film inductor of the disclosure includes the following steps 101 to 106.

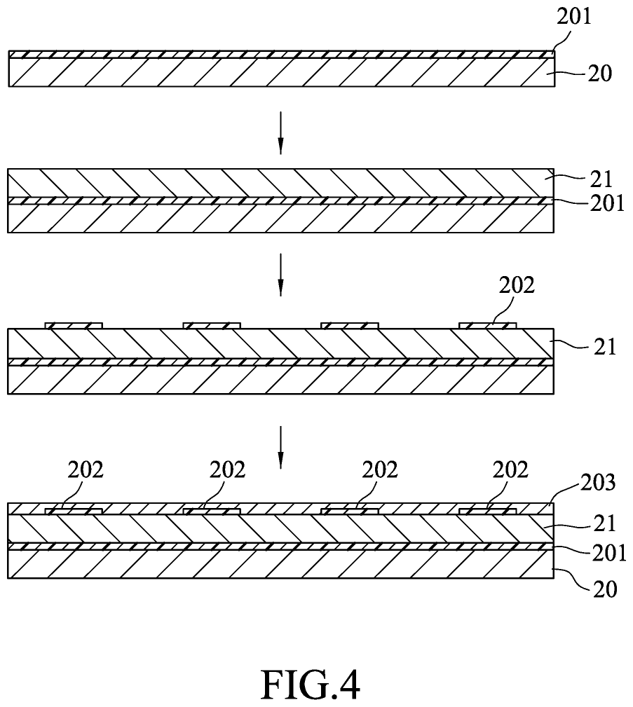

Referring to FIG. 4, in step 101, a separation film 201 is formed on a base plate 20, and then a first magnetic layer 21 is formed on the separation film 201, e.g., by compression molding a magnetic material. In this embodiment, a first insulating layer 202 having a coil pattern is further formed on the first magnetic layer 21, and then a seed layer 203 made of copper is formed on the first magnetic layer 21 and the first insulating layer 202. The base plate 20 is made of copper, and the separation film 201 is made of epoxy resin, but are not limited thereto.

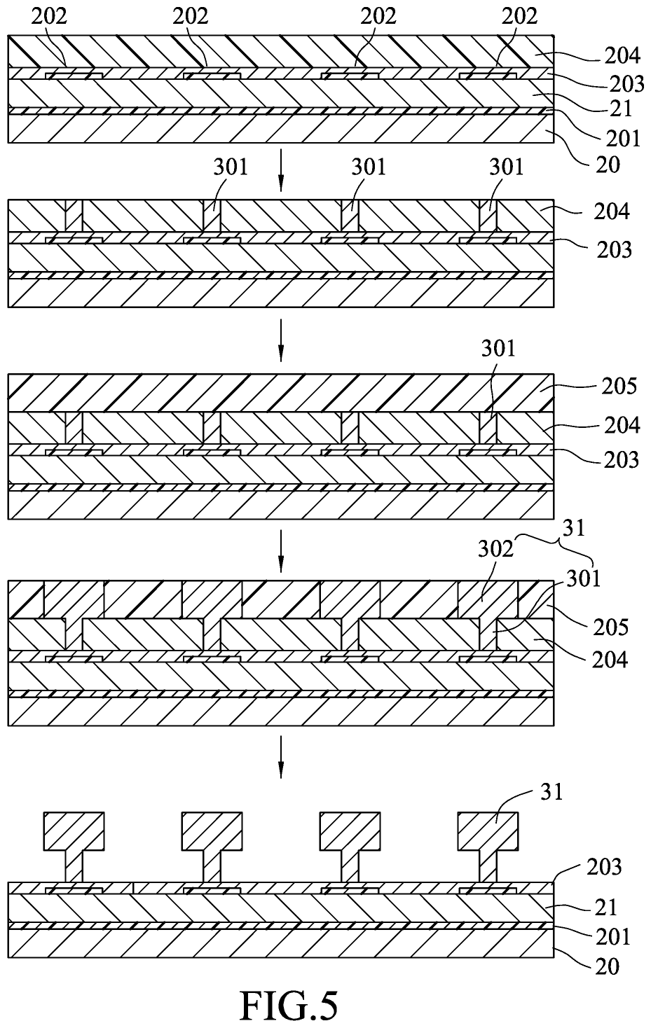

Referring to FIG. 5, in step 102, a coil unit 31 is formed on the first magnetic layer 21. To be specific, a first photoresist layer 204 is formed on the seed layer 203, and then the first photoresist layer 204 is subjected to exposure and developing procedures to remove a portion of the first photoresist layer 204 so that a portion of the seed layer 203 corresponding in position to the first insulating layer 202 is exposed from the first photoresist layer 204. Next, a first coil layer 301 is electroplated on the exposed portion of the seed layer 203, so as to obtain the coil unit 31 including the first coil layer 301.

To obtain the coil unit 31 including multiple coil layers (i.e., multi-layered structure), in this embodiment, a second photoresist layer 205 is further formed on the first coil layer 301 and the first photoresist layer 204. Thereafter, the second photoresist layer 205 is subjected to exposure and developing procedures to remove a portion of the second photoresist layer 205 so that the first coil layer 301 is exposed from the second photoresist layer 205. Subsequently, a second coil layer 302 is formed on the exposed first coil layer 301. The above procedures (i.e., forming a photoresist layer, subjecting the photoresist layer to exposure and developing procedures, and electroplating a coil layer) may be repeatedly conducted, so as to obtain the coil unit 31 having a desired number of coil layers. In this embodiment, the first coil layer 301 and the second coil layer 302 cooperatively form the coil unit 31, but is not limited thereto. Finally, the first and second photoresist layers 204, 205 are removed to expose the coil unit 31.

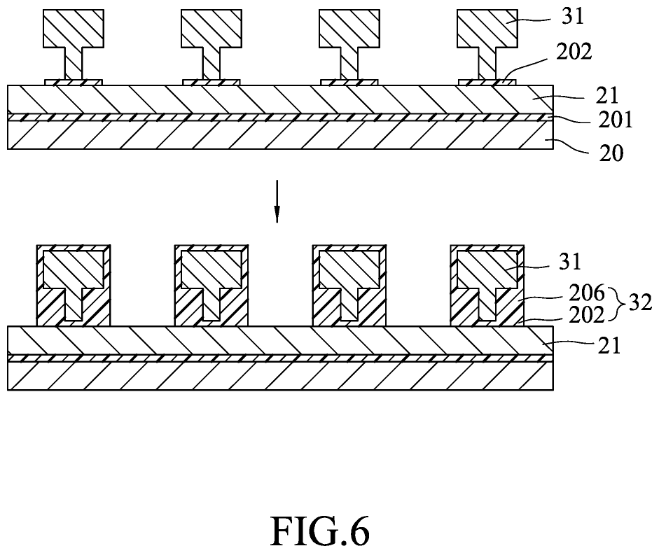

Referring to FIG. 6, in step 103, an electrically insulating member 32 is formed on the first magnetic layer 21. To be specific, the seed layer 203 is removed by etching to expose the first insulating layer 202, and then a second insulating layer 206 is formed around the exposed coil unit 31. The first insulating layer 202 and the second insulating layer 206 cooperatively form the electrically insulating member 32 that encloses the coil unit 31. The coil unit 31 and the electrically insulating member 32 cooperatively form the coil pattern.

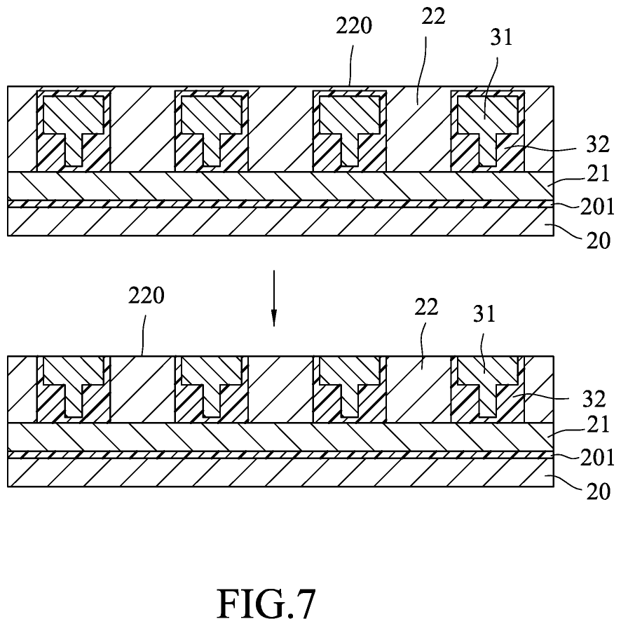

Referring to FIG. 7, in step 104, a second magnetic layer 22 is formed on the first magnetic layer 21 to cover the coil unit 31 and the electrically insulating member 32 and to fill a space defined by the coil pattern. The second magnetic layer 22 may be formed by compression molding a magnetic material that may be the same as that for making the first magnetic layer 21. It should be noted that, thickness of the second magnetic layer 22 may be optimized so that the thus manufactured thin-film inductor has a predetermined thickness. In this embodiment, a portion of the second magnetic layer 22 and a portion of the electrically insulating member 32 that are located opposite to the separation film 201 are removed, e.g., by a grinding procedure, such that the coil unit 31 is exposed from and flushed with the top surface 220 of the second magnetic layer 22.

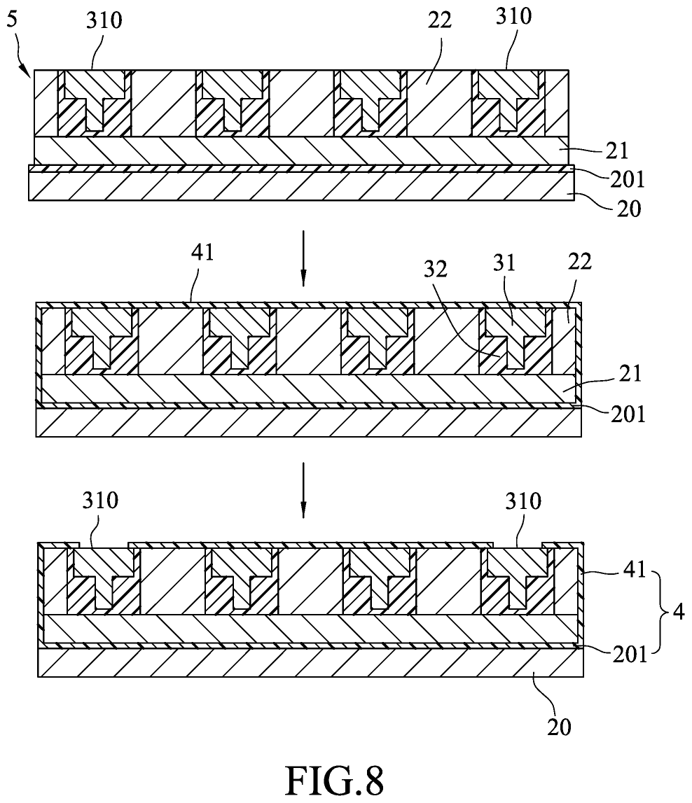

Referring to FIG. 8, in step 105, a peripheral portion of the second magnetic layer 22 and a peripheral portion of the first magnetic layer 21 are removed until a part of the separation film 201 below the peripheral portion of the first magnetic layer 21 is exposed, so as to obtain a semi-product 5 on the separation film 201. The semi-product 5 includes the coil unit 31, the electrically insulating member 32, and the first and second magnetic layers 21, 22.

Then, a cover insulating layer 41 is formed on the exposed separation film 201 and the semi-product 5 in such a manner that the two contact regions 310 of the coil unit 31 opposite to the first magnetic layer 21 are exposed. In this embodiment, the semi-product 5 is immersed in a colloidal solution (not shown) (e.g., epoxy resin solution), which is cured to form the cover insulating layer 41, and then a portion of the cover insulating layer 41 is removed by a laser beam to expose the two contact regions 310 of the coil unit 31. The cover insulating layer 41 and the separation film 201 cooperatively form a cover insulating element 4.

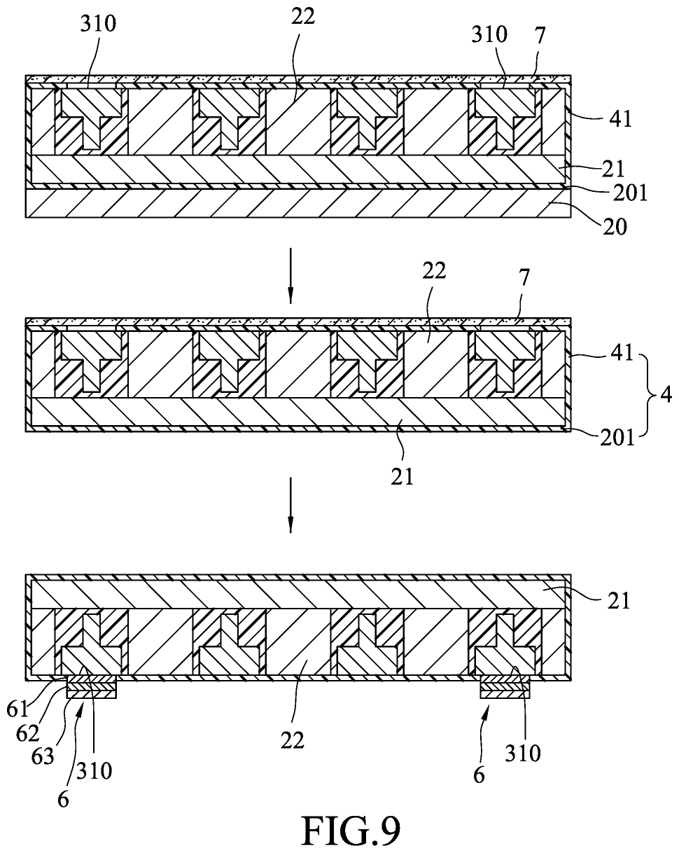

Referring to FIG. 9, in step 106, the base plate 20 is removed from the cover insulating element 4 to obtain the thin-film inductor. To be specific, in this embodiment, the cover insulating layer 41 and the two contact regions 310 of the coil unit 31 are covered with a thermal release tape 7, so as to protect the two contact regions 310 from being damaged during removal of the base plate 20 in a subsequent etching process. The thin-film inductor according to this disclosure is obtained following removal of the thermal release tape 7, and two terminal electrodes 6 may be further disposed on the two contact regions 310 of the coil unit 31, respectively. For example, the copper layer 61, the nickel layer 62, and the tin layer 63 are sequentially formed on the two contact regions 310 to obtain a respective one of the terminal electrodes 6.

In sum, by forming the separation film 201 on the base plate 20 followed by sequentially forming the first magnetic layers 21, the coil unit 31 and the second magnetic layer 22, the base plate 20 can be removed at the last step of the method for manufacturing the thin-film inductor according to this disclosure, thereby effectively reducing the thickness of the thin-film inductor (i.e., enabling miniaturization of the thin-film inductor of this disclosure). In addition, since the first and second magnetic layers 21, 22 are made of a magnetic material that serves as the base magnetic unit 2 to fill the space defined by the coil pattern of the coil structure 3, the inductance of the thin-film inductor according to this disclosure can be greatly improved.

In the description above, for the purposes of explanation, numerous specific details have been set forth in order to provide a thorough understanding of the embodiment. It will be apparent, however, to one skilled in the art, that one or more other embodiments may be practiced without some of these specific details It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for manufacturing a thin-film inductor, comprising the steps of:
a) forming a separation film on a base plate;
b) forming a first magnetic layer on the separation film;
c) forming, on the first magnetic layer, a coil unit and an electrically insulating member that encloses the coil unit, the coil unit and the electrically insulating member cooperatively forming a coil pattern;
d) forming a second magnetic layer on the first magnetic layer to cover the coil unit and the electrically insulating member and to fill a space defined by the coil pattern;
e) removing a peripheral portion of the second magnetic layer and a peripheral portion of the first magnetic layer until a part of the separation film below the peripheral portion of the first magnetic layer is exposed, so as to obtain a semi-product on the separation film;
f) forming a cover insulating layer on the exposed separation film and the semi-product in such a manner that two contact regions of the coil unit opposite to the first magnetic layer are exposed, the cover insulating layer and the separation film cooperatively forming a cover insulating element; and
g) removing the base plate from the cover insulating element to obtain the thin-film inductor.

2. The method according to claim 1, wherein step c) includes sub-steps of:
c1) forming a first insulating layer having the coil pattern on the first magnetic layer;
c2) forming a seed layer on the first magnetic layer and the first insulating layer, and then forming a first photoresist layer on the seed layer;
c3)) subjecting the first photoresist layer to exposure and developing procedures to remove a portion of the first photoresist layer so that a portion of the seed layer corresponding in position to the first insulating layer is exposed from the first photoresist layer;
c4) electroplating a first coil layer on the exposed portion of the seed layer, thereby obtaining the coil unit including the first coil layer.

3. The method according to claim 2, wherein step c) further includes, after sub-step c4), sub-step c5) of removing the first photoresist layer and the seed layer so as to expose the coil unit, and then forming a second insulating layer around the exposed coil unit, the first insulating layer and the second insulating layer cooperatively forming the electrically insulating member that encloses the coil unit.

4. The method according to claim 3, wherein:
step c) further includes, between sub-steps c4) and c5) sub-step c6) of forming a second photoresist layer on the first coil layer and the first photoresist layer, followed by subjecting the second photoresist layer to exposure and developing procedures to remove a portion of the second photoresist layer so that the first coil layer is exposed from the second photoresist layer, and then forming a second coil layer on the exposed first coil layer, the first coil layer and the second coil layer cooperatively forming the coil unit; and
in sub-step c5), the first and second photoresist layers and the seed layer are removed.

5. The method according to claim 1, further comprising, between step (d) and step (e), removing a portion of the second magnetic layer and a portion of the electrically insulating member that are located opposite to the separation film such that the coil unit is exposed from and flushed with the second magnetic layer.

6. The method according to claim 1, wherein in step f) the semi-product is immersed in a colloidal solution, followed by curing to form the cover insulating layer, and then a portion of the cover insulating layer is removed by a laser beam to expose the two contact regions of the coil unit.

7. The method according to claim 1, wherein step g) includes covering the cover insulating layer and the two contact regions of the coil unit with a thermal release tape, followed by removing the base plate by an etching process and then removing the thermal release tape.

8. The method according to claim 1, wherein in steps b) and d), the first and second magnetic layers are formed by compression molding.

9. The method according to claim 1, further comprising step h) of respectively forming two terminal electrodes on the two contact regions of the coil unit.

10. A thin-film inductor, comprising:
a base magnetic unit including a first magnetic layer and a second magnetic layer disposed on said first magnetic layer;
a coil structure including a coil unit that is disposed in said second magnetic layer, and an electrically insulating member that is disposed around said coil unit to isolate said coil unit from said base magnetic unit; and
a cover insulating element covering said base unit and said coil structure such that two contact regions of said coil unit opposite to said first magnetic layer are exposed from said cover insulating element.

11. The thin-film inductor according to claim 10, wherein said two contact regions of said coil unit are flushed with a surface of said second magnetic layer opposite to said first, magnetic layer.

12. The thin-film inductor according to claim 11, further comprising two terminal electrodes disposed on said two contact regions of said coil unit.
